(19) United States
(12) Patent Application Publication
(10) Pub. No.: US 2026/0141216 A1
(43) Pub. Date: May 21, 2026

(54) Method and System for Computer- Supported Analysis of Dynamic Differential Scanning Calorimetry Measurement Data

(71) Applicant: NETZSCH-Gerätebau GmbH, Selb (DE)

(72) Inventors: Andreas Postel, Oberkotzau (DE); Natalie Rudolph, Eußenheim (DE)

(21) Appl. No.: 19/392,356

(22) Filed: Nov. 18, 2025

Related U.S. Application Data
(60) Provisional application No. 63/722,622, filed on Nov. 20, 2024.

(30) Foreign Application Priority Data
Nov. 20, 2024 (DE) 10 2024 134 082.7

(51) Int. Cl. G06N 3/045; G06N 20/20

(52) U.S. Cl. CPC G06N 3/045; G06N 20/20

(57) ABSTRACT

A method for computer-supported analysis of dynamic differential scanning calorimetry measurement data. In addition, the present invention provides a system for computer-supported analysis of differential dynamic scanning calorimetry measurement data as well as a use of such a system, in particular, for recyclate analysis, and for analytic discrimination between various plastic samples.

### TECHNICAL FIELD

The present translation relates to a method and a system for computer-supported analysis of dynamic differential scanning calorimetry measurement data, in particular for analytic discrimination between various plastic samples, for example in the framework of a sorting procedure for recyclates.

### BACKGROUND

Recycling of waste is particularly important in the field of plastic refuse because its storage in the environment is harmful. Recycling of plastic can occur, for example, by means of the melting down and reshaping of plastic waste. To ensure efficiency of this type of recycling, it is customary before conversion to re-sort plastic disposables according to their material properties such as color and/or polymer type. Such sorting requires an examination of the composition of the plastic waste, a process that is often time-demanding and thus costly on account of the unforeseeable nature of the incoming flow of materials.

The degree of quality determination and quality assurance in characterizing the value of polymer recyclates depends on the quality of the employed separation and discrimination method in processing the output materials. In particular, the physical attributes of polymer recyclates must be capable of being specified and guaranteed within narrow tolerances for efficient reevaluation. Modern computer-supported data processing of measurements of efficient measuring devices can accelerate the quality analysis of polymer recyclates and make it more reliable. Examples of systems and methods for classifying and sorting plastic materials by the use of an image-processing system and one or more sensor systems are presented in the patent publication US 2022/0161298 A1.

The measurement principle of thermal analysis and, thus, in particular the physical measurement principle of dynamic differential scanning calorimetry (DSC) can assist in the experimental characterization of plastic waste of variable quality.

DSC measuring devices measure the heat capacity of a sample by recording the heat flow rate into the sample in comparison with a reference sample. From the resulting transmission of the heat flow in relation to the sample temperature or its time curve, it is possible to determine material transfer points such as a glass transition temperature or a melting temperature, a crystallinity degree of thermoplastic matrices, or a hardening behavior or residual reaction heat of duroplastic materials.

The publication WO 2022/170273 A1 discloses systems and methods for classifying and sorting variously colored plastic materials by using an image processing system or one or more sensor systems, so that the captured image data are processed in a machine learning system in order to identify or classify each of the materials for purposes of sorting. Publication EP 4 209 781 A1 discloses computer-implemented methods for thermal analysis of material samples.

Xin Lv, Shuyu Wang, Peng Shan, Yuliang Zhao, and Lei Zuo: “A machine learning-based method for automatic differential scanning calorimetry signal analysis,” Measurement, vol. 187, 110218, 2022, discloses computer-based evaluation methods for DSC measurement data on the basis of semi-automated machine learning models. Amir Bashirgonbadi, Yannick Ureel, Laurens Delva, Rudinei Fiorio, Kevin M. Van Geem, and Kim Ragaert: “Accurate determination of polyethylene (PE) and polypropylene (PP) content in polyolefin blends using machine learning-assisted differential scanning calorimetry (DSC) analysis,” Polymer Testing, vol. 131, 108353, February 2024, discloses the use of artificial intelligence in evaluating DSC measurement curves in characterizing polymer recyclates.

### SUMMARY

It is the object of the present invention to provide possibilities for more cost-effective, simpler and more rapid analysis of DSC measurement data. In particular, an aim of the present invention is to accelerate and to improve analytic discrimination between various plastic samples, for example in classifying and quantifying recyclates.

According to the invention, this object is achieved in each case by the statements in the independent claims.

Advantageous embodiments and refinements are derived from the subsidiary claims based on the independent claims as well as from the description referring to the drawings. The aforementioned embodiments and refinements can be freely combined with one another to the appropriate extent. Possible additional embodiments, refinements and implementations of the invention may also include combinations not explicitly cited before or subsequently in discussions of inventive properties described with respect to embodiments. In particular, the specialist will be able to add individual aspects, as improvements or supplements, to the basic version of the present invention.

The present invention is described in greater detail hereinafter, with reference to embodiments and the accompanying drawings.

### BRIEF DESCRIPTION OF THE DRAWINGS

The drawings are as follows:

FIG. 1 shows a flow diagram of a method for computer-assisted evaluation of dynamic differential scanning calorimetry data according to an embodiment of the invention.

FIG. 2 shows a schematic depiction of an embodiment of a system for computer-assisted evaluation of dynamic differential scanning calorimetry data, in particular for implementing the method according to FIG. 1.

FIG. 3 shows a schematic depiction of the recyclate sorting device according to an embodiment of the invention, comprising a system for computer-assisted evaluation of dynamic differential scanning calorimetry data.

In the drawings, elements, properties and components identical in function and in effect-unless otherwise indicated-in each case bear identical reference numbers.

### DETAILED DESCRIPTION

Although specific embodiments and refinements are predominantly depicted and described here, the specialist will prefer that a number of alternative and/or similar models of the depicted and described specific embodiments can replace the specific embodiments presented and described here, without any departure from the scope of the present invention. This statement should be taken as covering generally all revisions or modifications of specific embodiments described in this document.

The appended images are intended to provide further understanding of realizations of the invention and serve as clarification, in conjunction with the description of the declared principles and concepts of the invention. Other embodiments, and many of the cited advantages, are apparent with respect to the drawings. The drawings are to be understood merely as schematic illustrations, and the elements of the drawings are not necessarily shown as identical in scale with one another. Directional terminology such as “above,” “below,” “left,” “right,” “over,” “under,” “horizontal,” “vertical,” “in front,” “behind” and similar indications are employed only for purposes of clarification and do not serve to restrict general considerations to specific configurations as shown in the drawings.

Broken lines in the appended drawings indicate that the connections between the components connected by the broken lines are not necessarily required to be in physical contact with one another but instead can be coupled to one another wirelessly.

Reference is made in the following description to self-learning algorithms, which are used in an artificial intelligence (IA) system. In general terms, a self-learning algorithm duplicates cognitive functions that are classified as human thought processes according to human assessment. In this process, by acquiring new training information the self-learning algorithm can dynamically adapt the knowledge acquired over time to altered circumstances, in order to recognize and extrapolate patterns and conventions in the totality of the training information.

Self-learning algorithms as understood in the present invention can make use of all types of training that constitute human learning, such as for instance supervised learning, partly supervised learning, independent learning on the basis of generative, non-generative or deep adversarial networks (AN), reinforcement learning or active learning. Thus, in each instance, representation learning can be applied. Self-learning algorithms, as understood in the present invention, can perform, in particular, by feedback analysis, an iterative adaptation of parameters and attributes that are to be learned.

A self-learning algorithm in the sense of the present invention can build on regressors, a support vector network (SVN), a neural network such as a convolutional neural network (CNN), a Kohonen network, a recurring neural network, a time-delayed neural network (TDNN) or an oscillatory neural network (ONN), a random forest classifier, a decision tree classifier, a Monte Carlo network or a Bayesian classifier. Thus, a self-learning algorithm, as understood in the present invention, can employ genetic algorithms, k-means cluster algorithms such as Lloyd or MacQueen's algorithms or temporal-distance (TD) learning algorithms such as SARSA or Q-learning.

Differential scanning calorimetry measurement data, as used in the present invention, can in particular include all data sets which are generated by differential scanning calorimetry measuring devices or differential scanning calorimetry sensors. A differential scanning calorimetry measuring device is one which is used in order to measure the flow of heat through various substances, particularly in plastic samples. The device operates on the basis of differential scanning calorimetry (DSC), which aims to measure the amount of heat that is released in an enthalpy modification between a sample and a reference substance.

In this process a sample, for example a piece of plastic, is placed in a special chamber situated near an empty reference chamber. The two chambers are isolated and uniformly heated, for example by means of a heating pad under the chambers that ensures a continuous and predetermined heat supply. On the basis of the sample's heat capacity, endothermal or exothermal processes can result, as well as phase transitions to melting or sublimation points, allowing conclusions to be drawn concerning heat flows depending on temperature. The temperature change over time in controlled heating and cooling in both chambers is measured by heat sensors applied to each chamber. Differential scanning calorimetry measurements provide information on key values for characterizing thermal properties of plastic probes, such as glass transition temperatures, melting points, reaction enthalpies, degrees of crystallinity as well as specifical heat capacities.

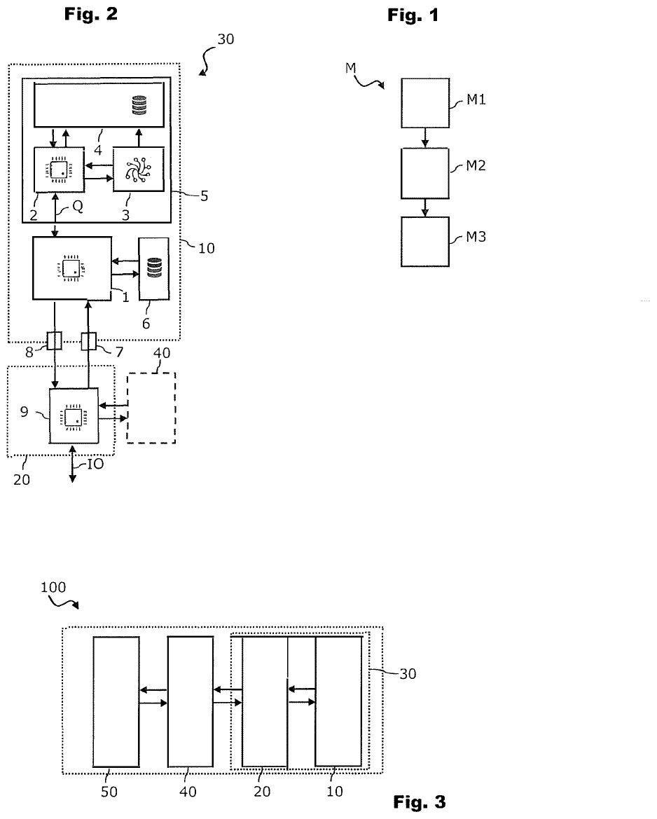

FIG. 1 shows a flow diagram of an inventive method M for computer-supported analysis of dynamic differential scanning calorimetry (DSC) data. The method M, in particular, can be implemented while using a system for computer-supported analysis of dynamic DSC data, for example of an inventive system 30 such as shown in FIG. 2. The method M, for example, can be employed for analytic discrimination between various plastic samples such as in sorting recyclates in a recyclate sorting device 100, as illustrated in FIG. 3.

In a first step M1 of the method M, a DSC measurement curve of an unknown sample is generated by a DSC measuring device 40. In a second step M2 of the method M, an AI system 10 ascertains a data pattern in the DSC measurement curve by using self-learning algorithms. Finally, on the basis of the ascertained data pattern, in a step M3 the classes of material in the DSC measurement curve are allocated to certain classes of material or certain materials by the AI system 10.

FIG. 2 illustrates an inventive system 30 for computer-supported analysis of dynamic DSC measurement data. The system 30, in particular, can be used to implement the method M of FIG. 1.

The system 30 comprises an AI system 10 and a control system 20 for a DSC measuring device 40. The control system 20 comprises a control processor 9, which is coupled by means of an input interface 7 and an output interface 8 with the AI system 10 on the one hand and with the DSC measuring device 40 on the other.

The control system 20 serves to control the DSC measuring device 40 in that the control processor 9 determines a control program for the DSC measuring device 40. For example, the control system 20 can specify the protocol parameters for a DSC measurement, such as heating rates or cooling rates for the sample, a number of the heat cycles that are to be performed, wait times between heating and cooling phases, or the like. DSC measurement data from the control processor 9 can be entered by the input interface 7 into the AI system 10. These DSC measurement data can be, for example, DSC measurement curves obtained from known or unknown samples or data transmitted to the control processor 9 by connected additional systems as computer-generated training data D.

The AI system 10 comprises a data analysis processor 1 as well as a machine learning system 5 (ML system). The ML system 5 in turn comprises an AI processor 2, a regulation generator 3 based on self-learning algorithms, and a reference regulation storage unit 4. The AI system 10 is situated above the data analysis processor 1 with the control processor 9 in bidirectional data communication. The control processor 9 can provide the AI system 10 first with DSC measurement curves as basis training data. These basis training data can serve as basis for detecting patterns and regularities in the shape of the DSC measurement curves by the regulation generator 3. The regulation generator 3, for example, can comprise regressors, a support vector network, a neural network, a random forest classifier, a decision tree classifier, a Monte Carlo network or a Bayesian classifier.

The detected patterns and regularities in the shape of the DSC measurement curves are first iteratively filed in training regulations, which are updated dynamically and regularly. From the training regulations, operational reference regulations can be formulated, which the regulation generator 3 stores in the reference regulation storage unit 4. When the AI processor 2 receives a request Q from the data analysis processor 1 to obtain data patterns in DSC measurement curves of unknown samples, the AI processor 2 consults the reference regulations filed in the reference regulations storage unit 4 as a reference. In response to this reference, the AI processor 2 determines which allocation to certain material classes or certain materials provides the best possible match with the material classes included in the acquired DSC measurement curve. The regulation generator 3 can update the reference regulations filed in the reference regulations storage 4 at periodic intervals on the basis of newly incoming DSC measurements or on the basis of new external specifications.

The results of the data pattern determination are re-conveyed by the AI processor 2 to the data analysis processor 1. The data analysis processor 1 can then issue an analytical result by means of the output interface 8 to the control processor 9, indicating which material class or which material should be allocated to the unknown sample that is the basis of the DSC measurement curve received by the control processor 9.

In addition, the AI system 10 can comprise a control program database 6, which is coupled with the data analysis processor 1. When the data analysis processor 1 receives from the control processor 9 a DSC measurement curve whose allocation to a certain material class or to a certain material by the AI processor 2 is possible only insufficiently or only with a degree of confidence below an adjustable confidence threshold, the data analysis processor 1 can propose to the control processor 9 a modification of the control program assignable by the control system 20. For example, in the event of an insufficient classification possibility of the material class or material, the AI processor 2, on the basis of a DSC measurement curve supporting an inquiry Q, can indicate which parts of the DSC measurement curve are problematic for the classification. On the basis of the parts of the DSC measurement curve indicated by the AI processor 2, the data analysis processor 1 can select control programs from the control program database 6 whose protocol parameters for a DSC measurement have introduced changes from the previously specified control program and thus a new DSC measurement could possibly resolve the problematic parts of the DSC measurement curve.

The components of the AI system 10, together with the control system 20, can be installed in a local data-processing center. It may also be possible to install individual components or system components elsewhere than in the local data-processing site. For example, it may be possible to operate the AI system 10 in a cloud environment so that the input interface 7 and the output interface 8 can be realized by way of remote access networks such as, for example, the internet.

In addition, the control processor 9 can comprise an input/output interface, by which the inputs and outputs 10 can be actuated by a user of the system 30.

FIG. 3 shows an exemplary implementation of a system 30 for computer-supported analysis of dynamic differential scanning calorimetry measurements in a recyclate sorting installation 100. The recyclate sorting installation 100 includes, for example, an automatic sorting system 50 for plastics. The automatic sorting system 50 is coupled with a DSC measuring device 40, which is configured to plot DSC measurement curves from unknown plastic samples that are processed in the automatic sorting system 50. The plotted DSC measurement curves are issued to a control system 20, which in submits them to an AI system 10 for automatic allocation of a certain material or a certain material class to the material classes contained in the plotted DSC measurement curves. The control system 20 and AI system 10, for example, can be operated as was explained in connection with FIG. 2.

The control system 20 serves in addition to control the DSC measuring device 40, in particular for applying protocol parameters for a DSC measurement by the DSC measuring device 40, such as for instance heating or cooling rates for the sample, a number of heating cycles that are to be executed, waiting periods between heating and cooling phases or the like.

Various characteristics for improving the rigor of the depiction in one or more examples are summarized in the preceding detailed description. It should thus be clear that the foregoing description is merely of illustrative nature, thus in no way to be considered as restrictive. It serves to disclose all alternatives, modifications and equivalents of the various characteristics and embodiments. Many other examples will be immediately recognizable to a specialist practiced in the field, as reflected in the foregoing description.

The embodiments have been selected and described in order to make it possible to present the principles and their practical application possibilities underlying the invention as clearly as possible. This should allow specialists to optimally modify and use the invention and its various embodiments according to the described purposes. The claims and the description both use the terms “containing” and “comprising” as neutral terms for the corresponding term “including.” In addition, any use of the terms “a” or “an” should not exclude a plurality of the characteristics and components being so described.

1. A system for computer-supported analysis of dynamic differential scanning calorimetry measurement data (DSC measurement data), comprising:
a control system for a DSC measuring device, having a control processor, configured to receive DSC measurement curves of unknown samples from the DSC measuring device;
an AI system having a data analysis processor and a machine learning system, wherein the AI system is situated above the data analysis processor in bi-directional data communication with the control processor and is configured to recognize data patterns in the DSC measurement curve of unknown samples by using self-learning algorithms and, on the basis of the acquired data patterns, to make an allocation of the material classes contained in the DSC measurement curves to certain material classes or certain materials.

2. The system according to claim 1, wherein the machine learning system comprises an AI processor, a regulation generator based on self-learning algorithms, and a reference regulation storage unit.

3. The system according to claim 2, wherein the regulation generator comprises regressors, a support vector network, a neural network, a random forest classifier, a decision tree classifier, a Monte Carlo network or a Bayesian classifier.

4. The system according to claim 1, wherein the control processor also is configured to subject the DSC measuring device to a control program in which values for protocol parameters for a DSC measurement are specified by the DSC measuring device.

5. The system according to claim 4, wherein the AI system comprises a control database which is coupled with the data analysis processor and in which various control programs for the DSC measuring device are stored.

6. The system according to claim 5, wherein the data analysis processor is configured to select from the control program database control programs whose protocol parameters for a DSC measurement have been modified since the control program previously specified by the control system in the event that the data analysis processor receives from the control processor a DSC measurement curve whose allocation to certain material classes or certain materials by the AI processor is possible only insufficiently or only to a degree of confidence below an adjustable confidence threshold.

7. The system according to claim 1, wherein the AI system is implemented in a cloud environment.

8. A method for computer-assisted evaluation of dynamic differential scanning calorimetry measurement data (DSC measurement data), comprising the following steps:
generating one or more DSC measurement curves of an unknown sample by a DSC measuring device;
ascertaining, by an AI system, a data pattern in the DSC measurement curves by using self-learning algorithms; and
allocation, on the basis of the ascertained data patterns, of the material classes contained in the DSC measurement curves to certain material classes or certain materials by the AI system.

9. The method according to claim 8, wherein the AI system comprises a machine learning system, which comprises-includes an AI processor, a regulation generator based on self-learning algorithms, and a reference regulation storage unit.

10. The method according to claim 9, wherein the regulation generator comprises regressors, a support vector network, a neural network, a random forest classifier, a decision tree classifier, a Monte Carlo network or a Bayesian classifier.

11. The method according to claim 8, wherein the DSC measuring device generates the DSC measurement curve according to a control program in which the values for protocol parameters for a DSC measurement are specified.

12. The method according to claim 11, wherein the AI system comprises a control program database which is coupled with the data analysis processor and in which various control programs for the DSC measuring device are stored.

13. The method according to claim 12, wherein from the control program database control programs are selected whose protocol parameters for a DSC measurement are modified with respect to the control program previously assigned by the control system in the event that the allocation to certain material classes or certain materials by the AI system is possible only insufficiently or only with a degree of confidence below an adjustable confidence threshold.

14. A use of a system for computer-supported analysis of dynamic differential scanning calorimetry measurement data (DSC measurement data), comprising:
a control system for a DSC measuring device, having a control processor, configured to receive DSC measurement curves of unknown samples from the DSC measuring device; and
an AI system having a data analysis processor and a machine learning system, wherein the AI system is situated above the data analysis processor in bi-directional data communication with the control processor and is configured to recognize data patterns in the DSC measurement curve of unknown samples by using self-learning algorithms and, on the basis of the acquired data patterns, to make an allocation of the material classes contained in the DSC measurement curves to certain material classes or certain materials, for analytical discrimination between various plastic samples.

15. A recyclate sorting device including a differential scanning calorimetry measuring device or DSC measuring device, and a system for computer-supported analysis of dynamic DSC measurement data comprising:
a control system for a DSC measuring device, having a control processor configured to receive DSC measurement curves of unknown samples from the DSC measuring device; and
an AI system having a data analysis processor and a machine learning system, wherein the AI system is situated above the data analysis processor in bi-directional data communication with the control processor and is configured to recognize data patterns in the DSC measurement curve of unknown samples by using self-learning algorithms and, on the basis of the acquired data patterns, to make an allocation of the material classes contained in the DSC measurement curves to certain material classes or certain materials.

16. The system according to claim 2, wherein the control processor also is configured to subject the DSC measuring device to a control program in which values for protocol parameters for a DSC measurement are specified by the DSC measuring device.

17. The system according to claim 2, wherein the AI system is implemented in a cloud environment.

18. The method according to claim 9, wherein the DSC measuring device generates the DSC measurement curve according to a control program in which the values for protocol parameters for a DSC measurement are specified.
